(19) United States
(12) Patent Application Publication
(10) Pub. No.: US 2024/0207777 A1
(43) Pub. Date: Jun. 27, 2024

(54) DIGLYCOLAMINE PROCESSING FOLLOWING ACID GAS REMOVAL FROM A GAS STREAM

(71) Applicant: SAUDI ARABIAN OIL COMPANY, Dhahran (SA)

(72) Inventor: Faisal Dagash ALBOQAMI, Khobar (SA)

(73) Assignee: SAUDI ARABIAN OIL COMPANY, Dhahran (SA)

(21) Appl. No.: 18/146,884

(22) Filed: Dec. 27, 2022

(51) Int. Cl. B01D 53/14; B01D 19/00

(52) U.S. Cl. CPC B01D 53/1425; B01D 19/0005; B01D 53/1456; B01D 53/1493; B01D 2252/20421; B01D 2252/20484; B01D 2257/304; B01D 2257/504

(57) ABSTRACT

Absorption of one or more acid gases from a gas stream may take place using diglycolamine as an absorbent. Methods for processing the absorbent after acid gas absorption may comprise: obtaining an at least partially spent aqueous amine solution from an absorber tower; removing at least a portion of the one or more acid gases from the at least partially spent aqueous amine solution in a regeneration tower to form an at least partially regenerated aqueous amine solution comprising diglycolamine and bis-(2-hydroxyethoxyethyl)urea; and introducing at least a first portion of the at least partially regenerated aqueous amine solution to a reclaimer under thermal conditions effective to revert at least a majority of the bis-(2-hydroxyethoxyethyl) urea to diglycolamine. The reclaimer is heated with a steam input that is in indirect contact with the at least partially regenerated aqueous amine solution and cooled with at least a diglycolamine stream.

### FIELD OF THE DISCLOSURE

The present disclosure relates generally to removal of one or more acid gases from a gas stream and, more particularly, to methods and systems utilizing diglycolamine as an acid gas sorbent for removing one or more acid gases from a gas stream.

### BACKGROUND OF THE DISCLOSURE

Removal of acid gases such as hydrogen sulfide (H₂S) and carbon dioxide (CO₂), for example, from a gas stream may be conducted for a number of reasons. For instance, acid gas removal may take place to make the gas stream suitable for commercial sale or use or to render the gas suitable for environmental discharge or flaring. Natural gas is but one example of a gas stream that may contain acid gases.

Techniques for removing one or more acid gases from a gas stream include, for example, chemical separation using by amine absorption, physical separation based on solubility in an organic solvent or an ionic liquid, cryogenic distillation (Ryan Holmes process), and membrane-based separations. Amine-based absorption is a highly advanced and commonly used technology for removing acid gases from natural gas and other gas streams. Amines commonly employed for removing acids gases from gas streams include, for example, monoethanolamine (MEA), diethanolamine (DEA), triethanolamine (TEA), and diglycolamine (DGA). Some amines may display selectivity for either hydrogen sulfide or carbon dioxide, whereas other amines are relatively non-selective.

Acid gas removal from a gas stream usually entails countercurrent contacting of the gas stream with an aqueous amine solution in an absorber tower. Co-current contacting of the aqueous amine solution and the gas stream is also possible in some cases. The aqueous solution exiting the absorber tower, sometimes referred to as “rich amine” since it has absorbed acid gases and has a decreased absorption capacity, is then processed to liberate the acid gases from the aqueous amine solution, thereby regenerating the amine for further use. Processing of the rich amine takes place in a separate regeneration tower to desorb the acid gases through direct steam contact, and the regenerated amine, sometimes referred to as “lean amine” since it has lost at least a portion of its acid gases and has its absorption capacity at least partially restored, is then returned to the absorber tower within an aqueous amine solution to perform additional acid gas separation. Optionally, the rich amine and/or the lean amine may be further heated or cooled upstream or downstream of the regeneration tower, respectively.

As indicated above, diglycolamine (DGA) is one example of an amine that may successfully remove acid gases from a gas stream. When using DGA for acid gas removal, inactivation of the DGA may take place through a side reaction before the rich amine reaches the regeneration tower. In particular, DGA may react with CO₂ or COS to form a carbamate precursor in the course of absorbing acid gases, which may then react further with DGA to form a urea byproduct (bis-(2-hydroxyethoxyethyl) urea-BHEEU), which is inactive toward acid gas absorption (BHEEU contains no basic nitrogen atoms). Although BHEEU can be reverted to DGA in a separate reclaimer at a temperature of 340° F. to 360° F. (171.1° C. to 182.2° C.), this operation has difficulties as well. Namely, temperature control in the reclaimer is often problematic, and above about 360° F. (182.2° C.), morpholine can form in increasing amounts instead of the desired reversion of BHEEU to DGA. Although morpholine is an amine with excellent acid gas absorption capacity, it is much more volatile than is DGA, and excessive formation of morpholine leads to a net loss of amine absorber from the system. Additionally, conventional reversion of BHEEU to DGA introduces reflux water rich in acid gases to the reclaimer as a means of regulating temperature. The introduction of acid gases to the reclaimer drives the system equilibrium toward BHEEU formation, thereby complicating the reversion operation and decreasing the quantity of active amine provided to the absorber tower. The series of reactions taking place when absorbing acid gases using DGA and reverting BHEEU to DGA are summarized in Reactions 1-4 below. A thiourea byproduct may also form by reacting 2 equivalents of DGA with COS or CS₂ (reaction not shown).

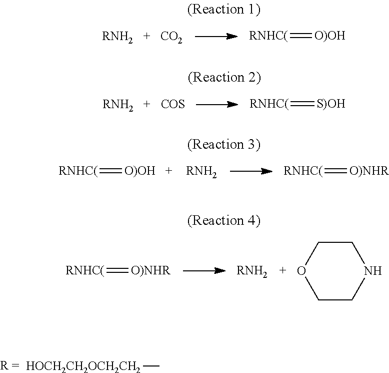

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods for processing a gas stream may comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution, in which the at least partially regenerated aqueous amine solution comprises one or more byproducts derived from the diglycolamine, the one or more byproducts comprising at least bis-(2-hydroxyethoxyethyl) urea; introducing at least a first portion of the at least partially regenerated aqueous amine solution to a reclaimer under thermal conditions effective to revert at least a majority of the bis-(2-hydroxyethoxyethyl) urea to diglycolamine, in which the reclaimer is heated with a steam input that is in indirect contact with the at least partially regenerated aqueous amine solution and cooled with at least a diglycolamine stream that is introduced directly into the at least partially regenerated aqueous amine solution in the reclaimer, thereby forming a regenerated aqueous amine solution; and recirculating at least a second portion of the at least partially regenerated aqueous amine solution to the absorber tower as at least a portion of the aqueous amine solution.

In another embodiment, methods for processing a gas stream may comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution, in which the at least partially regenerated aqueous amine solution comprises one or more byproducts derived from the diglycolamine, the one or more byproducts comprising at least bis-(2-hydroxyethoxyethyl) urea; and recirculating at least a portion of the at least partially regenerated aqueous amine solution to the absorber tower as at least a portion of the aqueous amine solution without further reverting the bis-(2-hydroxyethoxyethyl) urea to diglycolamine in a reclaimer, provided that the bis-(2-hydroxyethoxyethyl) urea comprises about 10 wt. % or less of the at least partially regenerated aqueous amine solution, based on total mass of the at least partially regenerated aqueous amine solution, or a rate of production bis-(2-hydroxyethoxyethyl) urea in the at least partially regenerated aqueous amine solution is about 3 wt. % or less per day, based on total mass of the at least partially regenerated aqueous amine solution.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

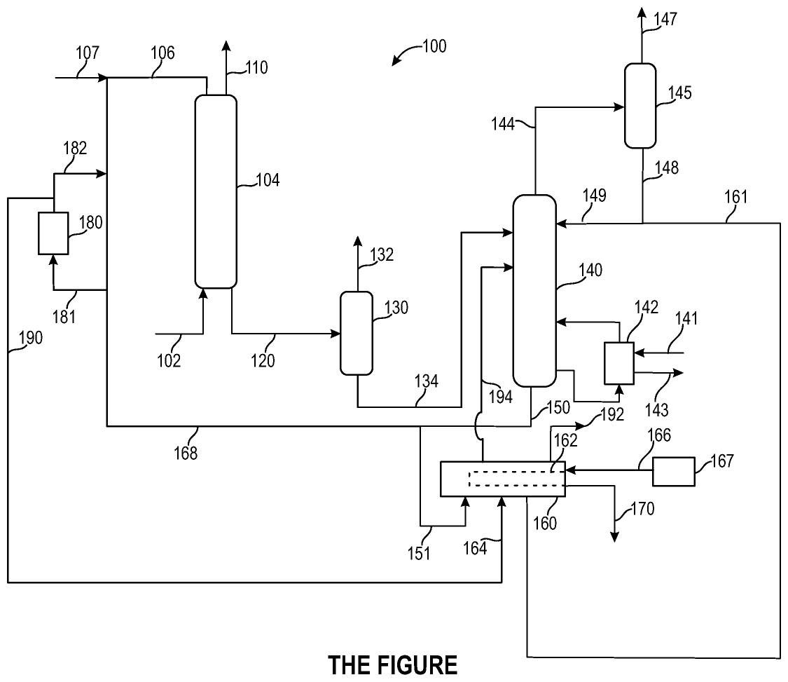

THE FIG. 1s a diagram of a portion of a gas stream treatment system and method employing diglycolamine as an acid gas sorbent, in which bis-(2-hydroxyethoxyethyl) urea, formed as a byproduct during acid gas treatment, is reverted to diglycolamine.

### DETAILED DESCRIPTION

Embodiments in accordance with the present disclosure generally relate to removal of one or more acid gases from a gas stream and, more particularly, to methods and systems utilizing diglycolamine as an acid gas sorbent for removing one or more acid gases from a gas stream.

There are often difficulties associated with utilizing diglycolamine (DGA) for removing acid gases from a gas stream. Formation of bis-(2-hydroxyethoxyethyl) urea (BHEEU), though a nuisance, may be effectively managed when reversion of BHEEU to DGA is conducted with strict temperature control. Alternately, the circulation rate of aqueous amine solution through an absorber tower may be increased to compensate for a decreased amount of active amine (e.g., due to BHEEU formation), but this approach may be undesirable as a long-term process solution. Of greater concern is the loss of DGA resulting from morpholine formation during reversion of BHEEU to DGA as a consequence of ineffective temperature control. Specifically, if the temperature during reversion exceeds 360° F.)(182.2° C., morpholine formation may become increasingly prevalent. While a mixed amine absorbent containing DGA and morpholine may give the initial appearance of effective amine reclamation, this is not the case due to the much greater volatility of morpholine compared to DGA. The high volatility of morpholine results in a gradual decrease in amine concentration, thereby leading to increasingly ineffective absorption of acid gases using the amine absorbent.

The present disclosure provides several complementary approaches for addressing the difficulties associated with using DGA as an amine absorbent for removing one or more acid gases from a gas stream, such as natural gas. First, the manner in which temperature control is maintained in a reclaimer may be altered in the disclosure herein. Conventional processes to revert BHEEU into DGA in a reclaimer utilize indirect contact of an aqueous amine solution with a medium-pressure steam source to promote heating and direct contact with reflux water from a reflux drum to promote cooling. The reflux drum is located downstream from a regeneration tower that desorbs (strips) the one or more acid gases from the rich amine, wherein the acid gas exiting the regeneration tower is cooled and further separated from reflux water exiting the regeneration tower in the reflux drum. The reflux water is removed from the reflux drum as a bottoms stream and returned to the regeneration tower, with a branch line providing some of the reflux water to the reclaimer. As the reflux water still contains high levels of residual CO₂ and H₂S, it may promote additional production of BHEEU or other byproducts and/or lessen the reversion of BHEEU back into DGA in the reclaimer. To address this difficulty, the systems and methods of the present disclosure replace (fully or partially) the reflux water coolant in the reclaimer with DGA produced elsewhere in the process, specifically an at least partially regenerated aqueous DGA solution. Specifically, an at least partially regenerated aqueous amine solution that has been passed through an amine filter may be utilized for this purpose, since the resulting filtered aqueous amine solution comprising DGA has a convenient temperature to promote cooling and a low level of fluid contaminants. Additional details are provided hereinbelow. Advantageously, this process modification may allow the temperature of the reclaimer to be regulated more effectively, while minimizing the input of species that decrease the reversion efficiency. At the very least, the methods of the present disclosure may decrease the amount of reflux water introduced to the reclaimer, thereby lessening the issues associated with using this fluid as a coolant.

Secondly, it was also discovered that it can sometimes be advantageous not to operate the reclaimer at all, such as in winter months and at other times when environmental temperatures are cooler and the gas stream introduction rate and/or the acid gas removal burden is lower. The lower gas stream introduction rate is largely a function of lower consumer demand during cooler months. When the gas stream introduction rate and/or the acid gas removal burden is lower, sufficient acid gas absorption capacity may remain in the aqueous amine solution even if significant amounts of DGA remain tied up as BHEEU. For example, under normal operating conditions, the DGA content of the aqueous amine solution treating the gas stream may range from about 45%-52% by mass, whereas at times having a lower acid gas absorption burden, 40%-45% DGA by mass in the aqueous amine solution may still afford acceptable acid gas absorption. A DGA content within the lower range may result when more of the DGA is tied up as non-absorbing BHEEU. When the reclaimer is not operating, the lean amine exiting the regeneration tower may traverse a line simply bypassing the reclaimer, or the lean amine may transit through the reclaimer with the reclaimer otherwise being inactive. This approach effectively protects the DGA in the form of BHEEU, thereby avoiding morpholine formation under reclamation conditions, until greater absorption capacity is needed at some time in the future. Specific parameters concerning when the reclaimer should or should not be operated are discussed in further detail herein.

The heat source for the reclaimer is medium-pressure steam from a utilities plant, which flows through a series of pipes in the interior of the reclaimer. Thus, the steam is in indirect contact with the lean amine in the reclaimer. The steam supplied from the utilities plant may be produced by a series of boilers that may also be supplying medium-pressure steam to other processes or areas of a plant. Although not operating the reclaimer seemingly would result in an excess steam inventory, this is not necessarily the case. First, any excess steam inventory that would ordinarily be utilized for heating the reclaimer may instead be diverted to other processes in need of heating. Moreover, when the reclaimer is eventually restarted and there is an even higher than usual amount of BHEEU in the lean amine, the excess steam inventory may be beneficial due to the high heat capacity of BHEEU in comparison to DGA. That is, additional steam capacity may be needed to promote heating due to the high amounts of BHEEU that may be present after extended periods of not operating the reclaimer. A higher amount of BHEEU may also necessitate greater low-pressure steam input to the regeneration tower from reboilers associated therewith, since it takes more aggressive heating to promote acid gas stripping in the regeneration tower due to the higher heat capacity of BHEEU, even though BHEEU itself does not promote amine absorption. Because of the more aggressive heating needed with increasing amounts of BHEEU, increasing amounts of low-pressure steam may be utilized, thereby providing more efficient operation than simply venting excess low-pressure steam inventory when produced. It should be understood, however, that if excess steam inventory does exist due to shutdown of the reclaimer or due to other factors, the excess steam inventory may be simply vented within significant consequences.

In the description herein, it is to be understood that the terms “amine solution” and “amine stream” and variants thereof are equivalent terms and are used interchangeably herein.

Accordingly, in some embodiments, methods for removing one or more acid gases from a gas stream may take place using an aqueous amine solution comprising diglycolamine, in which bis-(2-hydroxyethoxyethyl) urea forms to at least some degree upon interacting with the gas stream and processing the rich amine, and at least a portion of the bis-(2-hydroxyethoxyethyl) urea is reverted to diglycolamine in a reclaimer under conditions that disfavor formation of excessive morpholine. Such methods may comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution, in which the at least partially regenerated aqueous amine solution comprises one or more byproducts derived from the diglycolamine, the one or more byproducts comprising at least bis-(2-hydroxyethoxyethyl) urea; introducing at least a first portion of the at least partially regenerated aqueous amine solution to a reclaimer under thermal conditions effective to revert at least a majority of the bis-(2-hydroxyethoxyethyl) urea to diglycolamine, thereby forming a regenerated aqueous amine solution, and in which the reclaimer is heated with a steam input that is in indirect contact with the at least partially regenerated aqueous amine solution and cooled with at least a diglycolamine stream that is introduced directly to the at least partially regenerated aqueous amine solution in the reclaimer; and recirculating at least a second portion of the at least partially regenerated aqueous amine solution to the absorber tower as at least a portion of the aqueous amine solution. Optionally, reflux water obtained downstream from the regeneration tower may also be introduced to the reclaimer to provide additional cooling therein, as discussed further herein.

Embodiments of the present disclosure will now be described in detail with reference to THE FIGURE. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in THE FIGURE may vary without departing from the scope of the present disclosure.

THE FIG. 1s a diagram of a portion of gas stream treatment system and method employing diglycolamine as an acid gas sorbent, in which bis-(2-hydroxyethoxyethyl) urea, formed as a byproduct during acid gas treatment, is reverted to diglycolamine. As shown, system and method 100 includes absorber tower 104, which receives a gas stream via line 102 at or near the bottom of absorber tower 104 and an aqueous amine solution via line 106 at or near the top of absorber tower 104. The gas stream introduced via line 102 includes one or more acid gases, such as natural gas stream laden with one or more acid gases. The aqueous amine solution introduced via line 106 includes at least diglycolamine to promote absorption of at least a portion of the one or more acid gases from the gas stream within absorber tower 104. After removal of at least a portion of the one or more acid gases from the gas stream in absorber tower 104, an at least partially purified gas stream (sweetened gas stream) exits absorber tower 104 as an overhead stream via line 110. An at least partially spent aqueous amine solution exits absorber tower 104 as a bottoms stream via line 120 and is further processed according to the disclosure herein.

Contact between the gas mixture and the aqueous amine solution in absorber tower 104 may take place at a temperature of about 10° C. to about 80° C., such as about 10° C. to about 70° C., or about 10° C. to about 60° C., or about 10° C. to about 35° C., or about 30° C. to about 60° C., or about 50° C. to about 70° C., or about 40° C. to about 60° C. In addition, contact between the gas mixture and the aqueous amine solution in absorber tower 104 may be carried out at pressure ranging from about atmospheric pressure or slightly below (e.g., 0.9 atm to 1 atm, 0.09 MPa to 0.1 MPa) to a pressure of about 100 atm (10 MPa). In illustrative examples, the pressure in absorber tower 104 may range from about 1 atm to about 15 atm (0.1 MPa to 1.5 MPa), or about 5 atm to about 25 atm (0.5 MPa to 2.5 MPa).

The at least partially spent aqueous amine solution within line 120 is transported to flash drum 130, wherein an overhead stream is removed in line 132, and the remainder of the at least partially spent aqueous amine solution exits as a liquid stream via line 134. The overhead stream exiting flash drum 130 may comprise residual gas stream and/or a portion of the acid gases absorbed within the at least partially spent aqueous amine solution. The at least partially spent aqueous amine solution in line 134 is then introduced at or near the top of regeneration tower 140, wherein further removal (stripping) of the one or more acid gases may take place to form an at least partially regenerated aqueous amine solution as a bottoms stream. Steam is introduced at or near the bottom of regeneration tower 140 from reboiler 142 to promote stripping of the one or more acid gases from the at least partially spent aqueous amine solution. The steam introduced from reboiler 142 is low-pressure steam, which may be supplied at a pressure of about 15 atm (1.5 MPa) or below, or about 10 atm (1.0 MPa) or below, or about 5 atm (0.50 MPa) or below, such as about 3 atm (0.3 MPa) to about 10 atm (1.0 MPa) or about 4 atm (0.4 MPa) to about 6 atm (0.6 MPa). Low-pressure steam may be introduced to reboiler 142 via line 141, and condensate may be removed via line 143. The one or more acid gases liberated from the at least partially spent aqueous amine solution, along with reflux water, exit regeneration tower 140 as an overhead stream via line 144. The overhead stream in line 144 enters reflux drum 145 to separate the one or more acid gases from the reflux water. After separation, the one or more acid gases exit reflux drum 145 as an overhead stream in line 147, and the reflux water exits as a bottoms stream in line 148. Line 148 is in fluid communication with regeneration tower 140 via line 149, which returns at least a portion of the reflux water to regeneration tower 140. Optionally, the remainder of the reflux water may be conveyed via line 161 to reclaimer 160, as discussed subsequently. Specifically, the reflux water conveyed via line 161 to reclaimer 160 may provide additional cooling therein.

As described in more detail above, the diglycolamine in the aqueous amine solution forms one or more byproducts in the course of treating the gas stream in absorber tower 104. Specifically, the one or more byproducts may comprise at least bis-(2-hydroxyethoxyethyl) urea. Stripping of the one or more acid gases in regeneration tower 140 does not significantly revert the bis-(2-hydroxyethoxyethyl) urea to diglycolamine, nor does significant formation of morpholine occur. As such, the aqueous amine solution exiting regeneration tower 140 via line 150 still contains bis-(2-hydroxyethoxyethyl) urea in addition to diglycolamine and may be referred to herein as an at least partially regenerated aqueous amine solution. Although the at least partially regenerated aqueous amine solution obtained from regeneration tower 140 is lean in acid gases, it remains laden with bis-(2-hydroxyethoxyethyl) urea and has diminished acid gas absorption capacity as a result. The diminished acid gas absorption capacity may remain sufficient to promote continued acid gas removal, as discussed further herein, or the bis-(2-hydroxyethoxyethyl) urea may be reverted to diglycolamine under specified conditions in other instances.

Suitable examples of regeneration tower 140 may include any of those conventionally used in the gas processing industry. Stripping temperatures in regeneration tower 140 may range from about 80° C. to about 180° C., or about 110° C. to about 150° C., or about 100° C. to about 130° C., for example. Above about 360° F. (182.2° C.), formation of morpholine in regeneration tower 140 may begin to occur.

When needed, reversion of the bis-(2-hydroxyethoxyethyl) urea into diglycolamine may take place thermally, preferably within a temperature range of 340° F. to 360° F. (171.1° C. to 182.2° C.) by providing the at least partially regenerated aqueous amine solution or a portion thereof in line 150 to reclaimer 160. If the temperature is below about 340° F. (171.1° C.), insufficient reversion of bis-(2-hydroxyethoxyethyl) urea may occur, whereas when the temperature exceeds 360° F. (182.2° C.) formation of morpholine may become increasingly prevalent instead of the desired reversion of bis-(2-hydroxyethoxyethyl) urea into diglycolamine. Reclaimer 160 includes heating loop 162 (shown in phantom) and cooling line 164 to maintain the temperature of the at least partially regenerated aqueous amine solution introduced via line 151 within the desired range. Heating loop 162 includes one or more tubes through which steam flows, such that the steam is in indirect contact with the at least partially regenerated aqueous amine solution in the interior of reclaimer 160. As shown, the steam may be provided to heating loop 162 via line 166 extending from utilities plant 167, which provides medium-pressure steam from one or more boilers. The medium-pressure steam may supplied at a pressure of about 15 atm (1.5 MPa) or above, or about 20 atm (2.0 MPa) or above, or about 30 atm (3.0 MPa) or above, such as about 20 atm (2.0 MPa) to about 30 atm (3.0 MPa), or about 22 atm (2.2 MPa) to about 28 atm (2.8 MPa), or about 24 atm (2.4 MPa) to about 26 MPa. Preferably, the medium-pressure steam is supplied to reclaimer 160 is at a pressure of 25.1 atm (2.54 MPa) to about 25.9 atm (2.62 MPa). Steam is condensed within reclaimer 160 and exits as condensate via line 170. The condensate exiting reclaimer 160 may be recirculated to utilities plant 167 if desired. When reversion of reversion of bis-(2-hydroxyethoxyethyl) urea is performed, at least a portion of the bis-(2-hydroxyethoxyethyl) urea in line 150 may be conveyed by line 151 to reclaimer 160. The remainder of the bis-(2-hydroxyethoxyethyl) urea in line 150 (or the entirety of the bis-(2-hydroxyethoxyethyl) urea in line 150, if bis-(2-hydroxyethoxyethyl) urea is not being reverted) is conveyed by return line 168, which ultimately rejoins line 106 for diglycolamine recycling to absorber tower 104. Cooling line 164 provides a diglycolamine stream to reclaimer 160, which is then combined in reclaimer 160 with the at least partially regenerated aqueous amine solution introduced separately thereto via line 151. Alternately, cooling line 164 may join line 151 to provide a combined stream to reclaimer 160. If reflux water is provided to reclaimer 160 via line 161, the reflux water may supplement the cooling effects afforded by the diglycolamine stream provided via cooling line 164.

Any source of diglycolamine or an aqueous solution thereof may be provided to reclaimer 160 as a cooling stream via cooling line 164, provided that the diglycolamine or aqueous diglycolamine solution has a temperature lower than that present in reclaimer 160. As shown in THE FIGURE, the diglycolamine stream within cooling line 164 may be advantageously provided from return line 168 or a branch stream processed therefrom before the diglycolamine stream is returned to absorber tower 104 via line 106. More specifically, amine filter 180 may be present within a branch line extending from return line 168 to process at least a portion of the at least partially regenerated aqueous amine solution returning to absorber tower 104. For example, amine filter 180 may process about 5% to about 10% by volume of the regenerated aqueous amine solution being returned to absorber tower 104 to afford a filtered diglycolamine stream (filtered diglycolamine aqueous solution). The portion of the regenerated aqueous amine stream comprising diglycolamine being processed may exit return line 168 via line 181, pass through amine filter 180, and subsequently rejoin return line 168 via line 182 as a filtered diglycolamine stream.

The filtered diglycolamine stream within line 182 may have a temperature within a range suitable for regulating the temperature in reclaimer 162. After passing through amine filter 180, the regenerated aqueous amine solution may have a temperature of about 54.4° C. to about 65.6° C.(130° F. to about 150° F.), for example. As such, at least a portion of the filtered diglycolamine stream within line 182 may be withdrawn via branch line 190, which then joins cooling line 164 for providing the filtered diglycolamine stream to reclaimer 160 for promoting temperature regulation therein. Alternately, the entirety of the filtered diglycolamine stream exiting amine filter 180 may be conveyed to cooling line 164, in which case branch line 190 may provide a direct connection to cooling line 164, and line 182 may be optionally be omitted. In still another process configuration, a portion of the at least partially regenerated aqueous amine solution within return line 168 (i.e., downstream from line 151) may be provided to reclaimer 160, provided the at least partially regenerated aqueous amine stream is withdrawn from a location in return line 168 that is suitable to promote cooling in reclaimer 160.

Although reclaimer 160 has been depicted in a horizontal orientation in THE FIGURE, it is to be appreciated that vertical orientations also may be effectively utilized in to promote reversion of bis-(2-hydroxyethoxyethyl) urea into diglycolamine as well. Vent 192 may be used to remove volatile species generated during reversion of bis-(2-hydroxyethoxyethyl) urea into diglycolamine. A reverted diglycolamine stream is removed from reclaimer 160 via line 194 and is returned to regeneration tower 140 for further processing.

Steam introduced to heating loop 162 from utilities plant 167 may have a temperature of about 440° F. (226.7° C.), and the rate of steam introduction to heating loop 162 may be adjusted in response to the target temperature within reclaimer 160.

The diglycolamine stream introduced to reclaimer 160 via cooling line 164 may have a temperature of ranging from about 40° C. to about 100° C., or about 50° C. to about 70° C., such as about 60° C. (140° F.) and may promote cooling by intimately mixing with the at least partially regenerated aqueous amine solution received from regeneration tower 140 via line 151. Like the rate of steam introduction to reclaimer 160, the rate of diglycolamine introduction to reclaimer 160 via cooling line 164 (and/or reflux water introduced via line 161) may be adjusted in response to the target temperature therein. In addition, since the diglycolamine stream is mixed with the at least partially regenerated aqueous amine stream in reclaimer 160, the rate of diglycolamine introduction may be adjusted to support a desired diglycolamine concentration in the regenerated aqueous amine solution obtained from reclaimer 160 and provided to regeneration tower 140 via line 194, as the amine concentration in the at least partially regenerated aqueous amine stream impacts the amount of diglycolamine introduced to absorber tower 104. In non-limiting examples, the aqueous amine solution introduced to the absorber tower may comprise 45 wt. % to 52 wt. % diglycolamine, based on total mass of the aqueous amine solution.

After bis-(2-hydroxyethoxyethyl) urea has been sufficiently reverted to diglycolamine in reclaimer 160, a regenerated aqueous amine solution is conveyed to regeneration tower 140 via line 194. It is to be appreciated that complete reversion of bis-(2-hydroxyethoxyethyl) urea to diglycolamine need not necessarily take place in reclaimer 160, provided that a sufficient amount of diglycolamine remains present in the aqueous amine solution to promote absorption of the one or more acid gases from the gas stream once the diglycolamine is eventually recirculated to absorber tower 104. If needed, makeup diglycolamine or aqueous amine solution may be introduced to line 106 via makeup line 107 (or alternately introduced directly to absorber tower 104), such as to account for fluid losses or to compensate for amine losses resulting from morpholine formation. Other locations for introducing makeup diglycolamine or aqueous amine solution may also be envisioned by one having ordinary skill in the art.

While not explicitly described or depicted in THE FIGURE, it is to be appreciated that there may be other operational components at various locations within system and method 100 including, but not limited to, additional piping, valves, pumps, heat exchangers, filters, and the like that may be needed to implement a particular process configuration.

As indicated above, by maintaining the at least partially regenerated aqueous amine solution at a temperature ranging from 340° F. to 360° F. (171.1° C. to 182.2° C.) in the reclaimer, bis-(2-hydroxyethoxyethyl) urea may be reverted to diglycolamine at an acceptable rate while discouraging excessive formation of morpholine. By cooling the at least partially regenerated aqueous amine solution in the reclaimer with a diglycolamine stream (as opposed to solely with reflux water stream still laden with one or more acid gases), the foregoing may be accomplished more readily. However, if the morpholine concentration within the regenerated aqueous amine stream becomes excessive, such as a morpholine concentration of about 3 wt. % or more based on total mass of the regenerated aqueous amine solution, the temperature range may be narrowed to further discourage morpholine formation. Specifically, the at least partially regenerated aqueous amine solution in the reclaimer may be maintained at a temperature ranging from 340° F. to 350° F. (171.1° C. to 176.7° C.) if at least a portion of the bis-(2-hydroxyethoxyethyl) urea is converted to morpholine and the regenerated aqueous amine solution comprises about 3 wt. % or more morpholine. Once the morpholine concentration has decreased to below about 3 wt. % in the regenerated aqueous amine solution, the temperature within the reclaimer may again be expanded into the range of 340° F. to 360° F. (171.1° C. to 182.2° C.). It is to be appreciated that 3 wt. % or more morpholine represents a practical working threshold for morpholine formation, and the value may be adjusted depending on particular circumstances. For instance, the working threshold for morpholine formation may range from about 1 wt. % to about 5 wt. %, or about 2 wt. % to about 4 wt. %, or about 2.5 wt. % to about 3.5 wt. % in some cases.

In addition or as an alternative to promoting cooling in the reclaimer with a diglycolamine stream, advanced processing controls may be implemented to determine when and/or how the reclaimer may be operated to maintain diglycolamine and bis-(2-hydroxyethoxyethyl) urea within acceptable levels for specified operating conditions, while discouraging excessive morpholine formation or eliminating morpholine formation altogether. In particular, under the specified operating conditions, an at least partially regenerated aqueous amine solution may be recirculated directly to an absorber tower, either bypassing a reclaimer altogether or after passing through a reclaimer that is not currently operating (i.e., an inoperative reclaimer). That is, under the specified operating conditions, the amount of diglycolamine in the aqueous amine solution may remain acceptable for promoting absorption of one or more acid gases from a gas stream, even when significant amounts of bis-(2-hydroxyethoxyethyl) urea are present. By limiting reversion of bis-(2-hydroxyethoxyethyl) urea in the foregoing manner, formation of morpholine may be suppressed by reverting the bis-(2-hydroxyethoxyethyl) urea when it is deemed necessary to do so. For example, in some instances, the amount of diglycolamine may reside within about 40 wt. % to about 45 wt. %, based on the aqueous amine solution recirculated to the absorber tower, when buildup of bis-(2-hydroxyethoxyethyl) urea is allowed to take place under specified conditions. Additional details are provided hereinafter.

Accordingly, methods of the present disclosure may comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution, in which the at least partially regenerated aqueous amine solution comprises one or more byproducts derived from the diglycolamine, the one or more byproducts comprising at least bis-(2-hydroxyethoxyethyl) urea; and recirculating at least a portion of the at least partially regenerated aqueous amine solution to the absorber tower as at least a portion of the aqueous amine solution without further reverting the bis-(2-hydroxyethoxyethyl) urea to diglycolamine in a reclaimer, provided that the bis-(2-hydroxyethoxyethyl) urea comprises about 10 wt. % or less of the at least partially regenerated aqueous amine solution, based on total mass of the at least partially regenerated aqueous amine solution, or a rate of production bis-(2-hydroxyethoxyethyl) urea in the at least partially regenerated aqueous amine solution is about 3 wt. % or less per day, based on total mass of the at least partially regenerated aqueous amine solution.

The foregoing may be accomplished in a system and method like system and method 100 shown in THE FIGURE, in which the at least partially regenerated aqueous amine solution in reclaimer 160 may be cooled through introduction of at least a diglycolamine stream. Alternately, the advanced processing methods for managing the reversion of bis-(2-hydroxyethoxyethyl) urea to diglycolamine, as described herein, may take place in conventional systems and methods otherwise identical to system and method 100, except introducing a water stream (e.g., reflux water laden with one or more acid gases in line 161) as the sole cooling source of reclaimer 160, instead of cooling reclaimer 160 with a diglycolamine stream originating downstream from amine filter 180. In view of the similarity of this alternative system and method configuration, and in the further interest of brevity, this alternative configuration is not described in further detail herein.

As indicated above, to avoid reverting bis-(2-hydroxyethoxyethyl) urea to diglycolamine, the at least partially regenerated aqueous amine solution may pass through (transit) a reclaimer that is currently inoperative (or being shut down), or the at least partially regenerated aqueous amine solution may traverse a line bypassing a reclaimer, typically wherein the reclaimer is currently inoperative (or being shut down). That is, the advanced processing methods disclosed herein may be implemented to determine when direct recirculation of an at least partially regenerated aqueous amine solution to an absorber tower may take place and/or when a reclaimer may be shut down or bypassed in response to specified operating conditions.

If the at least partially regenerated aqueous amine solution is not presently being routed to a reclaimer when reversion of bis-(2-hydroxyethoxyethyl) urea is needed, the methods of the present disclosure may comprise routing the at least partially regenerated aqueous amine solution to the reclaimer and/or establishing thermal conditions in the reclaimer to revert at least a majority of the bis-(2-hydroxyethoxyethyl) urea to diglycolamine to produce a regenerated aqueous amine solution, and then conveying at least a portion of the regenerated aqueous amine solution to the regeneration tower. Upon leaving the regeneration tower, the regenerated aqueous amine solution may subsequently return to the absorber tower within the at least partially regenerated aqueous amine solution. Again, the reversion of bis-(2-hydroxyethoxyethyl) urea to diglycolamine taking place in the reclaimer may be conducted such that morpholine formation is eliminated or suppressed to a desired degree. Conditions sufficient to suppress or eliminate morpholine formation under specified operating conditions are described hereinafter.

When the at least partially regenerated aqueous amine solution comprises about 10 wt. % or less bis-(2-hydroxyethoxyethyl) urea (alternately about 15 wt. % or less or about 5 wt. % or less), based on total mass of the at least partially regenerated aqueous amine solution, and one or more of the following conditions are met, reversion of bis-(2-hydroxyethoxyethyl) urea to diglycolamine may be avoided or stopped. That is, the following conditions define when reversion of the at least partially regenerated aqueous amine solution leaving the regeneration tower may be avoided. As used herein, the term “pick-up ratio” refers to the molar ratio of acid gas to amine when contacting an aqueous amine solution with a gas stream containing the acid gas.
a) A pick-up ratio for the at least partially regenerated aqueous amine solution is about 0.4 or less and a monitored location (e.g., a monitored tray) in the absorber tower has a temperature of about 190° F. (87.8° C.) or less, provided a circulation rate of the at least partially regenerated aqueous amine solution to the absorber tower is greater than a minimum allowable circulation rate. The monitored tray may be selected to provide representative data of absorber performance. Once reversion of bis-(2-hydroxyethoxyethyl) urea to diglycolamine is avoided or stopped, the circulation rate may be reduced to set the pick-up ratio to within a range of about 0.4 to about 0.5, such as about 0.45.
b) A pick-up ratio for the at least partially regenerated aqueous amine solution is about 0.4 or more, preferably about 0.5 or more, and a monitored location (e.g., a monitored tray) in the absorber tower has a temperature of about 160° F. (71.1° C.) or greater, provided a circulation rate of the at least partially regenerated aqueous amine solution to the absorber tower is less than a maximum allowable circulation rate. The monitored tray may be selected to provide representative data of absorber performance. Once reversion of bis-(2-hydroxyethoxyethyl) urea to diglycolamine is avoided or stopped, the circulation rate may be increased to set the pick-up ratio to within a range of about 0.4 to about 0.5, such as about 0.45.
c) A pick-up ratio for the at least partially regenerated aqueous amine solution is about 0.4 or less and a monitored location (e.g., a monitored tray) in the absorber tower has a temperature of about 190° F. (87.8° C.) or greater, provided a circulation rate of the at least partially regenerated aqueous amine solution to the absorber tower is less than a maximum allowable circulation rate. The monitored tray may be selected to provide representative data of absorber performance. Once reversion of bis-(2-hydroxyethoxyethyl) urea to diglycolamine is avoided or stopped, the circulation rate may be increased to set the pick-up ratio to within a range of about 0.4 to about 0.5, such as about 0.45. The temperature of the monitored location in the absorber tower may also be reduced to below 190° F. upon setting the desired pick-up ratio.

If condition a) is present (in combination with about 10 wt. % or less bis-(2-hydroxyethoxyethyl) urea in the at least partially regenerated aqueous amine solution), the at least partially regenerated aqueous amine solution may continue to be recirculated without reverting the bis-(2-hydroxyethoxyethyl) urea under thermal regeneration conditions, as described in further detail above. The circulation rate may be changed (decreased) to a circulation rate greater than or equal to the minimum allowable circulation rate to set the pick-up ratio within a range of about 0.4 to about 0.5, such as about 0.45.

If condition b) is present (in combination with about 10 wt. % or less bis-(2-hydroxyethoxyethyl) urea in the at least partially regenerated aqueous amine solution), the at least partially regenerated aqueous amine solution may continue to be recirculated without reverting the bis-(2-hydroxyethoxyethyl) urea under thermal regeneration conditions, provided that the rate of recirculation is changed (increased) to a circulation rate less than or equal to the maximum allowable circulation rate. More specifically, the methods described herein may further comprise increasing the circulation rate of the at least partially regenerated aqueous amine solution to the absorber tower to a rate less than or equal to the maximum allowable circulation rate while lowering the pick-up ratio to about 0.5 or less, such as within a range of about 0.4 to about 0.5, such as a value of about 0.45, and maintaining the monitored location in the absorber tower at a temperature of about 160° F. (71.1° C.) or greater.

If condition c) is present (in combination with about 10 wt. % or less bis-(2-hydroxyethoxyethyl) urea in the at least partially regenerated aqueous amine solution), the at least partially regenerated aqueous amine solution may continue to be recirculated without reverting the bis-(2-hydroxyethoxyethyl) urea under thermal regeneration conditions, provided that the rate of recirculation is changed (increased) to a circulation rate less than or equal to the maximum allowable circulation rate. More specifically, the methods described herein may further comprise increasing the circulation rate of the at least partially regenerated aqueous amine solution to the absorber tower to a rate less than or equal to the maximum allowable circulation rate while setting the pick-up ratio within a range of 0.4 to 0.5, such as a value of about 0.45, and decreasing the temperature of the monitored location in the absorber tower to a temperature of about 190° F. (87.8° C.) or less.

In the foregoing, the minimum and maximum recirculation rates may vary over a wide range. In non-limiting examples, the recirculation rates may range from a minimum of about 4500 gallons per minute (gpm) to a maximum of about 8000 gpm.

If the bis-(2-hydroxyethoxyethyl) urea concentration in the at least partially regenerated aqueous amine solution exceeds 10 wt. % (alternately about 15 wt. % or about 5 wt. %) based on total mass of the at least partially regenerated aqueous amine solution and/or bis-(2-hydroxyethoxyethyl) urea is produced in the regenerated aqueous amine solution (if already reverting bis-(2-hydroxyethoxyethyl) urea to diglycolamine in a reclaimer), the reclaimer may be operated outside the normal operating temperature range to decrease the amount of bis-(2-hydroxyethoxyethyl) urea that is present in order to maintain adequate acid gas absorption capacity. That is, the operating temperature may be increased above the normal 340° F.-360° F. (171.1° C. to) 182.2° C. operating temperature range, if bis-(2-hydroxyethoxyethyl) urea concentrations have become sufficiently high that reversion to diglycolamine is needed to maintain adequate absorption capacity, even at the cost of increased conversion to morpholine. More specifically, if either of the foregoing conditions is met, specifically if bis-(2-hydroxyethoxyethyl) urea is produced at a rate of about 3 wt. % or more per day, based on total mass of the regenerated aqueous amine solution, methods of the present disclosure may further comprise increasing the temperature of the at least partially regenerated aqueous amine solution in the reclaimer to within a range of 360° F. to 380° F. (182.2° C. to 193.3° C.), or 365° F. to 375° F. (185° C. to 190.6° C.), or 368° F. to 372° F. (186.7° C. to 188.9° C.), or about 370° F. (187.8° C.) in order to promote reversion of bis-(2-hydroxyethoxyethyl) urea to diglycolamine, albeit with increased production of morpholine. Once the bis-(2-hydroxyethoxyethyl) urea is again produced at a rate of about 3 wt. % or less per day (alternately 5 wt. % or less per day, or 4 wt. % or less per day, based upon total mass of the regenerated aqueous amine solution, the temperature may be returned to within a range of 340° F. to 360° F. (171.1° C. to 182.2° C.), preferably 350° F. to 360° F. (176.7° C. to 182.2° C.). If the rate of morpholine formation exceeds about 3 wt. % per day (alternately 5 wt. % per day, or 4 wt. % per day), the reclaimer may be shut down or bypassed.

Embodiments disclosed herein include:

A. Methods for processing a gas stream. The methods comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution; wherein the at least partially regenerated aqueous amine solution comprises one or more byproducts derived from the diglycolamine, the one or more byproducts comprising at least bis-(2-hydroxyethoxyethyl) urea; introducing at least a first portion of the at least partially regenerated aqueous amine solution to a reclaimer under thermal conditions effective to revert at least a majority of the bis-(2-hydroxyethoxyethyl) urea to diglycolamine, thereby forming a regenerated aqueous amine solution; wherein the reclaimer is heated with a steam input that is in indirect contact with the at least partially regenerated aqueous amine solution and cooled with at least a diglycolamine stream that is introduced directly into the at least partially regenerated aqueous amine solution in the reclaimer; and recirculating at least a second portion of the at least partially regenerated aqueous amine solution to the absorber tower as at least a portion of the aqueous amine solution.

B. Methods for processing a gas stream. The methods comprise: contacting a gas stream comprising one or more acid gases with an aqueous amine solution comprising diglycolamine in an absorber tower; absorbing at least a portion of the one or more acid gases from the gas stream into the aqueous amine solution in the absorber tower to form an at least partially spent aqueous amine solution; removing at least a portion of the one or more acid gases from the at least partially spent aqueous amine solution in a regeneration tower to form an at least partially regenerated aqueous amine solution; wherein the at least partially regenerated aqueous amine solution comprises one or more byproducts derived from the diglycolamine, the one or more byproducts comprising at least bis-(2-hydroxyethoxyethyl) urea; and recirculating at least a portion of the at least partially regenerated aqueous amine solution to the absorber tower as at least a portion of the aqueous amine solution without further reverting the bis-(2-hydroxyethoxyethyl) urea to diglycolamine in a reclaimer, provided that the bis-(2-hydroxyethoxyethyl) urea comprises about 10 wt. % or less of the at least partially regenerated aqueous amine solution, based on total mass of the at least partially regenerated aqueous amine solution, or a rate of production bis-(2-hydroxyethoxyethyl) urea in the at least partially regenerated aqueous amine solution is about 3 wt. % or less per day, based on total mass of the at least partially regenerated aqueous amine solution.

Each of embodiments A and B may have one or more of the following additional elements in any combination:

Element 1: wherein the at least partially regenerated aqueous amine solution in the reclaimer is maintained at a temperature ranging from 340° F. to 360° F. (171.1° C. to 182.2° C.).

Element 2: wherein the at least partially regenerated aqueous amine solution in the reclaimer is maintained at a temperature ranging from 340° F. to 350° F. (171.1° C. to 176.7° C.) if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

Element 3: wherein the aqueous amine solution introduced to the absorber tower comprises 45 wt. % to 52 wt. % diglycolamine, based on total mass of the aqueous amine solution.

Element 4: wherein the second portion of the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

Element 5: wherein the regenerated aqueous amine solution is conveyed from the reclaimer to the regeneration tower.

Element 6: wherein the reclaimer is present but is bypassed by the at least partially regenerated aqueous amine solution.

Element 7: wherein the at least partially regenerated aqueous amine solution comprises about 10 wt. % or less bis-(2-hydroxyethoxyethyl) urea, based on total mass of the at least partially regenerated aqueous amine solution, and one of the following conditions is met:
a) a pick-up ratio for the at least partially regenerated aqueous amine solution is about 0.4 or less, and a monitored location in the absorber tower has a temperature of about 190° C. or less, provided a circulation rate of the at least partially regenerated aqueous amine solution to the absorber tower is greater than a minimum allowable circulation rate,
b) a pick-up ratio for the at least partially regenerated aqueous amine solution is about 0.5 or more and a monitored location in the absorber tower has a temperature of about 160° F. or greater, provided a circulation rate of the at least partially regenerated aqueous amine solution to the absorber tower is less a maximum than allowable circulation rate, or
c) a pick-up ratio for the at least partially regenerated aqueous amine solution is about 0.4 or less and a monitored location in the absorber tower has a temperature of about 190° F. or greater, provided a circulation rate of the at least partially regenerated aqueous amine solution to the absorber tower is less than a maximum allowable circulation rate.

Element 8: wherein the pick-up ratio for the at least partially regenerated aqueous amine solution is about 0.4 or less and the monitored location in the absorber tower has a temperature of about 190° F. or less, and the method further comprises: reducing the circulation rate of the at least partially regenerated aqueous amine solution to the absorber tower to a rate less than or equal to the minimum allowable flow rate until the pick-up ratio rises to within a range of about 0.4 to about 0.5.

Element 9: wherein the pick-up ratio for the at least partially regenerated aqueous amine solution is about 0.5 or more and the monitored location in the absorber tower has a temperature of about 160° F. or greater, and the method further comprises: increasing the circulation rate of the at least partially regenerated aqueous amine solution to the absorber tower to a rate less than or equal to the maximum allowable circulation rate until the pick-up rate falls to within a range of about 0.4 to about 0.5 while also maintaining the monitored location in the absorber tower at about 160° F. or greater.

Element 10: wherein the pick-up ratio for the at least partially regenerated aqueous amine solution is about 0.4 or less and the monitored location in the absorber tower has a temperature of about 190° F. or greater, and the method further comprises: increasing the circulation rate of the at least partially regenerated aqueous amine solution to the absorber tower to a rate less than or equal to the maximum allowable circulation rate until the pick-up ratio is within a range of about 0.4 to about 0.5 and the monitored location in the absorber tower has a temperature of about 190° C. or less.

Element 11: wherein at least a first portion of the at least partially regenerated aqueous amine solution is recirculated to the absorber tower and at least a second portion of the at least partially regenerated aqueous amine solution is introduced to a reclaimer under thermal conditions effective to revert at least a majority of the bis-(2-hydroxyethoxyethyl) urea to diglycolamine, thereby forming a regenerated aqueous amine solution.

Element 12: wherein the regenerated aqueous amine solution is conveyed from the reclaimer to the regeneration tower.

Element 13: wherein the at least partially regenerated aqueous amine solution in the reclaimer is maintained at a temperature ranging from 340° F. to 360° F. (171.1° C. to 182.2° C.), provided that bis-(2-hydroxyethoxyethyl) urea is produced at a rate of about 3 wt. % or less per day, based on total mass of the regenerated aqueous amine solution.

Element 14: wherein bis-(2-hydroxyethoxyethyl) urea is produced at a rate of about 3 wt. % or more per day, based on total mass of the regenerated aqueous amine solution, and the method further comprises: increasing the temperature of the at least partially regenerated aqueous amine solution in the reclaimer to within a range of 360° F. to 380° F.; and returning the temperature of the at least partially regenerated aqueous amine solution in the reclaimer to within a range of 340° F. to 360° F. once bis-(2-hydroxyethoxyethyl) urea is produced at a rate of about 3 wt. % or less per day, based on total mass of the regenerated aqueous amine solution.

Element 15: wherein the at least partially regenerated aqueous amine solution in the reclaimer is maintained at a temperature ranging from 340° F. to 350° F. if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

Element 16: wherein the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

Element 17: wherein the aqueous amine solution introduced to the absorber tower comprises 40 wt. % to 45 wt. % diglycolamine, based on total mass of the aqueous amine solution.

By way of non-limiting example, exemplary combinations applicable to A include, but are not limited to: 1 and 2; 1-3; 1 and 4; 1, 2, and 4; 1 and 5; 1, 2, and 5; 1 or 2, and 3; 1 or 2, and 4; 1 or 2, and 5; 2 and 3; 2 and 4; 2 and 5; 3 and 4; 3 and 5; and 4 and 5. By way of further non-limiting example, exemplary combinations applicable to B include, but are not limited to, 6 and 7; 6, 7, and 8; 6, 7, and 9; 6, 7, and 10; 6 and 11; 6 and 12; 6 and 16; 6 and 17; 7, 8, 9, or 10, and 11; 7, 8, 9, or 10, and 12; 7, 8, 9, or 10, and 13; 7, 8, 9, or 10, and 14; 7, 8, 9, or 10, and 15; 7, 8, 9, or 10, and 16; 7, 8, 9, or 10, and 17; 12 and 13; 12 and 14; 12 and 15; 12 and 16; 12 and 17; 13 and 14; 13 and 15; 13 and 16; 13 and 17; 14 and 15; 14 and 16; 14 and 17; 15 and 16; 15 and 17; and 16 and 17.

The present disclosure is further directed to the following non-limiting clauses:

Clause 1. A method comprising:
contacting a gas stream comprising one or more acid gases with an aqueous amine solution comprising diglycolamine in an absorber tower;
absorbing at least a portion of the one or more acid gases from the gas stream into the aqueous amine solution in the absorber tower to form an at least partially spent aqueous amine solution;
removing at least a portion of the one or more acid gases from the at least partially spent aqueous amine solution in a regeneration tower to form an at least partially regenerated aqueous amine solution;
   wherein the at least partially regenerated aqueous amine solution comprises one or more byproducts derived from the diglycolamine, the one or more byproducts comprising at least bis-(2-hydroxyethoxyethyl) urea;
introducing at least a first portion of the at least partially regenerated aqueous amine solution to a reclaimer under thermal conditions effective to revert at least a majority of the bis-(2-hydroxyethoxyethyl) urea to diglycolamine, thereby forming a regenerated aqueous amine solution;
   wherein the reclaimer is heated with a steam input that is in indirect contact with the at least partially regenerated aqueous amine solution and cooled with at least a diglycolamine stream that is introduced directly into the at least partially regenerated aqueous amine solution in the reclaimer; and recirculating at least a second portion of the at least partially regenerated aqueous amine solution to the absorber tower as at least a portion of the aqueous amine solution.

Clause 2. The method of clause 1, wherein the at least partially regenerated aqueous amine solution in the reclaimer is maintained at a temperature ranging from 340° F. to 360° F. (171.1° C. to 182.2° C.)

Clause 3. The method of clause 2, wherein the at least partially regenerated aqueous amine solution in the reclaimer is maintained at a temperature ranging from 340° F. to 350° F. (171.1° C. to 176.7° C.) if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

Clause 4. The method of any one of clauses 1-3, wherein the aqueous amine solution introduced to the absorber tower comprises 45 wt. % to 52 wt. % diglycolamine, based on total mass of the aqueous amine solution.

Clause 5. The method of any one of clauses 1-4, wherein the second portion of the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

Clause 6. The method of any one of clauses 1-5, wherein the regenerated aqueous amine solution is conveyed from the reclaimer to the regeneration tower.

Clause 7. A method comprising:
contacting a gas stream comprising one or more acid gases with an aqueous amine solution comprising diglycolamine in an absorber tower;
absorbing at least a portion of the one or more acid gases from the gas stream into the aqueous amine solution in the absorber tower to form an at least partially spent aqueous amine solution;
removing at least a portion of the one or more acid gases from the at least partially spent aqueous amine solution in a regeneration tower to form an at least partially regenerated aqueous amine solution;
   wherein the at least partially regenerated aqueous amine solution comprises one or more byproducts derived from the diglycolamine, the one or more byproducts comprising at least bis-(2-hydroxyethoxyethyl) urea; and
   recirculating at least a portion of the at least partially regenerated aqueous amine solution to the absorber tower as at least a portion of the aqueous amine solution without further reverting the bis-(2-hydroxyethoxyethyl) urea to diglycolamine in a reclaimer, provided that the bis-(2-hydroxyethoxyethyl) urea comprises about 10 wt. % or less of the at least partially regenerated aqueous amine solution, based on total mass of the at least partially regenerated aqueous amine solution, or a rate of production bis-(2-hydroxyethoxyethyl) urea in the at least partially regenerated aqueous amine solution is about 3 wt. % or less per day, based on total mass of the at least partially regenerated aqueous amine solution.

Clause 8. The method of clause 7, wherein the reclaimer is present but is bypassed by the at least partially regenerated aqueous amine solution.

Clause 9. The method of clause 7 or clause 8, wherein the at least partially regenerated aqueous amine solution comprises about 10 wt. % or less bis-(2-hydroxyethoxyethyl) urea, based on total mass of the at least partially regenerated aqueous amine solution, and one of the following conditions is met:
a) a pick-up ratio for the at least partially regenerated aqueous amine solution is about 0.4 or less, and a monitored location in the absorber tower has a temperature of about 190° C. or less, provided a circulation rate of the at least partially regenerated aqueous amine solution to the absorber tower is greater than a minimum allowable circulation rate,
b) a pick-up ratio for the at least partially regenerated aqueous amine solution is about 0.5 or more and a monitored location in the absorber tower has a temperature of about 160° F. or greater, provided a circulation rate of the at least partially regenerated aqueous amine solution to the absorber tower is less than a maximum allowable circulation rate, or
c) a pick-up ratio for the at least partially regenerated aqueous amine solution is about 0.4 or less and a monitored location in the absorber tower has a temperature of about 190° F. or greater, provided a circulation rate of the at least partially regenerated aqueous amine solution to the absorber tower is less than a maximum allowable circulation rate.

Clause 10. The method of clause 9, wherein the pick-up ratio for the at least partially regenerated aqueous amine solution is about 0.4 or less and the monitored location in the absorber tower has a temperature of about 190° F. or less, the method further comprising:
reducing the circulation rate of the at least partially regenerated aqueous amine solution to the absorber tower to a rate less than or equal to the minimum allowable flow rate until the pick-up ratio rises to within a range of about 0.4 to about 0.5.

Clause 11. The method of clause 9, wherein the pick-up ratio for the at least partially regenerated aqueous amine solution is about 0.5 or more and the monitored location in the absorber tower has a temperature of about 160° F. or greater, the method further comprising:
increasing the circulation rate of the at least partially regenerated aqueous amine solution to the absorber tower to a rate less than or equal to the maximum allowable circulation rate until the pick-up rate falls to within a range of about 0.4 to about 0.5 while also maintaining the monitored location in the absorber tower at about 160° F. or greater.

Clause 12. The method of clause 9, wherein the pick-up ratio for the at least partially regenerated aqueous amine solution is about 0.4 or less and the monitored location in the absorber tower has a temperature of about 190° F. or greater, the method further comprising:
increasing the circulation rate of the at least partially regenerated aqueous amine solution to the absorber tower to a rate less than or equal to the maximum allowable circulation rate until the pick-up ratio is within a range of about 0.4 to about 0.5 and the monitored location in the absorber tower has a temperature of about 190° C. or less.

Clause 13. The method of clause 7, wherein at least a first portion of the at least partially regenerated aqueous amine solution is recirculated to the absorber tower and at least a second portion of the at least partially regenerated aqueous amine solution is introduced to a reclaimer under thermal conditions effective to revert at least a majority of the bis-(2-hydroxyethoxyethyl) urea to diglycolamine, thereby forming a regenerated aqueous amine solution.

Clause 14. The method of clause 13, wherein the regenerated aqueous amine solution is conveyed from the reclaimer to the regeneration tower.

Clause 15. The method of clause 13 or clause 14, wherein the at least partially regenerated aqueous amine solution in the reclaimer is maintained at a temperature ranging from 340° F. to 360° F. (171.1° C. to 182.2° C.), provided that bis-(2-hydroxyethoxyethyl) urea is produced at a rate of about 3 wt. % or less per day, based on total mass of the regenerated aqueous amine solution.

Clause 16. The method of clause 13 or clause 14, wherein bis-(2-hydroxyethoxyethyl) urea is produced at a rate of about 3 wt. % or more per day, based on total mass of the regenerated aqueous amine solution, the method further comprising:
increasing the temperature of the at least partially regenerated aqueous amine solution in the reclaimer to within a range of 360° F. to 380° F.; and
returning the temperature of the at least partially regenerated aqueous amine solution in the reclaimer to within a range of 340° F. to 360° F. once bis-(2-hydroxyethoxyethyl) urea is produced at a rate of about 3 wt. % or less per day, based on total mass of the regenerated aqueous amine solution.

Clause 17. The method of clause 13 or clause 14, wherein the at least partially regenerated aqueous amine solution in the reclaimer is maintained at a temperature ranging from 340° F. to 350° F. if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

Clause 18. The method of clause 13 or clause 14, wherein the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

Clause 19. The method of any one of clauses 7-18, wherein the aqueous amine solution introduced to the absorber tower comprises 40 wt. % to 45 wt. % diglycolamine, based on total mass of the aqueous amine solution.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
contacting a gas stream comprising one or more acid gases with an aqueous amine solution comprising diglycolamine in an absorber tower;
absorbing at least a portion of the one or more acid gases from the gas stream into the aqueous amine solution in the absorber tower to form an at least partially spent aqueous amine solution;
removing at least a portion of the one or more acid gases from the at least partially spent aqueous amine solution in a regeneration tower to form an at least partially regenerated aqueous amine solution;
wherein the at least partially regenerated aqueous amine solution comprises one or more byproducts derived from the diglycolamine, the one or more byproducts comprising at least bis-(2-hydroxyethoxyethyl) urea;
introducing at least a first portion of the at least partially regenerated aqueous amine solution to a reclaimer under thermal conditions effective to revert at least a majority of the bis-(2-hydroxyethoxyethyl) urea to diglycolamine, thereby forming a regenerated aqueous amine solution;
wherein the reclaimer is heated with a steam input that is in indirect contact with the at least partially regenerated aqueous amine solution and cooled with at least a diglycolamine stream that is introduced directly into the at least partially regenerated aqueous amine solution in the reclaimer; and
recirculating at least a second portion of the at least partially regenerated aqueous amine solution to the absorber tower as at least a portion of the aqueous amine solution.

2. The method of claim 1, wherein the at least partially regenerated aqueous amine solution in the reclaimer is maintained at a temperature ranging from 340° F. to 360° F. (171.1° C. to) 182.2° C.

3. The method of claim 2, wherein the at least partially regenerated aqueous amine solution in the reclaimer is maintained at a temperature ranging from 340° F. to 350° F. (171.1° C. to 176.7° C.) if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

4. The method of claim 1, wherein the aqueous amine solution introduced to the absorber tower comprises 45 wt. % to 52 wt. % diglycolamine, based on total mass of the aqueous amine solution.

5. The method of claim 1, wherein the second portion of the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

6. The method of claim 1, wherein the regenerated aqueous amine solution is conveyed from the reclaimer to the regeneration tower.

7. A method comprising:
contacting a gas stream comprising one or more acid gases with an aqueous amine solution comprising diglycolamine in an absorber tower;
absorbing at least a portion of the one or more acid gases from the gas stream into the aqueous amine solution in the absorber tower to form an at least partially spent aqueous amine solution;
removing at least a portion of the one or more acid gases from the at least partially spent aqueous amine solution in a regeneration tower to form an at least partially regenerated aqueous amine solution;
wherein the at least partially regenerated aqueous amine solution comprises one or more byproducts derived from the diglycolamine, the one or more byproducts comprising at least bis-(2-hydroxyethoxyethyl) urea; and
recirculating at least a portion of the at least partially regenerated aqueous amine solution to the absorber tower as at least a portion of the aqueous amine solution without further reverting the bis-(2-hydroxyethoxyethyl) urea to diglycolamine in a reclaimer, provided that the bis-(2-hydroxyethoxyethyl) urea comprises about 10 wt. % or less of the at least partially regenerated aqueous amine solution, based on total mass of the at least partially regenerated aqueous amine solution, or a rate of production bis-(2-hydroxyethoxyethyl) urea in the at least partially regenerated aqueous amine solution is about 3 wt. % or less per day, based on total mass of the at least partially regenerated aqueous amine solution.

8. The method of claim 7, wherein the reclaimer is present but is bypassed by the at least partially regenerated aqueous amine solution.

9. The method of claim 7, wherein the at least partially regenerated aqueous amine solution comprises about 10 wt. % or less bis-(2-hydroxyethoxyethyl) urea, based on total mass of the at least partially regenerated aqueous amine solution, and one of the following conditions is met:
a) a pick-up ratio for the at least partially regenerated aqueous amine solution is about 0.4 or less, and a monitored location in the absorber tower has a temperature of about 190° C. or less, provided a circulation rate of the at least partially regenerated aqueous amine solution to the absorber tower is greater than a minimum allowable circulation rate,
b) a pick-up ratio for the at least partially regenerated aqueous amine solution is about 0.5 or more and a monitored location in the absorber tower has a temperature of about 160° F. or greater, provided a circulation rate of the at least partially regenerated aqueous amine solution to the absorber tower is less than a maximum allowable circulation rate, or
c) a pick-up ratio for the at least partially regenerated aqueous amine solution is about 0.4 or less and a monitored location in the absorber tower has a temperature of about 190° F. or greater, provided a circulation rate of the at least partially regenerated aqueous amine solution to the absorber tower is less than a maximum allowable circulation rate.

10. The method of claim 9, wherein the pick-up ratio for the at least partially regenerated aqueous amine solution is about 0.4 or less and the monitored location in the absorber tower has a temperature of about 190° F. or less, the method further comprising:
reducing the circulation rate of the at least partially regenerated aqueous amine solution to the absorber tower to a rate less than or equal to the minimum allowable flow rate until the pick-up ratio rises to within a range of about 0.4 to about 0.5.

11. The method of claim 9, wherein the pick-up ratio for the at least partially regenerated aqueous amine solution is about 0.5 or more and the monitored location in the absorber tower has a temperature of about 160° F. or greater, the method further comprising:
increasing the circulation rate of the at least partially regenerated aqueous amine solution to the absorber tower to a rate less than or equal to the maximum allowable circulation rate until the pick-up rate falls to within a range of about 0.4 to about 0.5 while also maintaining the monitored location in the absorber tower at about 160° F. or greater.

12. The method of claim 9, wherein the pick-up ratio for the at least partially regenerated aqueous amine solution is about 0.4 or less and the monitored location in the absorber tower has a temperature of about 190° F. or greater, the method further comprising:
increasing the circulation rate of the at least partially regenerated aqueous amine solution to the absorber tower to a rate less than or equal to the maximum allowable circulation rate until the pick-up ratio is within a range of about 0.4 to about 0.5 and the monitored location in the absorber tower has a temperature of about 190° C. or less.

13. The method of claim 7, wherein at least a first portion of the at least partially regenerated aqueous amine solution is recirculated to the absorber tower and at least a second portion of the at least partially regenerated aqueous amine solution is introduced to a reclaimer under thermal conditions effective to revert at least a majority of the bis-(2-hydroxyethoxyethyl) urea to diglycolamine, thereby forming a regenerated aqueous amine solution.

14. The method of claim 13, wherein the regenerated aqueous amine solution is conveyed from the reclaimer to the regeneration tower.

15. The method of claim 13, wherein the at least partially regenerated aqueous amine solution in the reclaimer is maintained at a temperature ranging from 340° F. to 360° F. (171.1° C. to) 182.2° C., provided that bis-(2-hydroxyethoxyethyl) urea is produced at a rate of about 3 wt. % or less per day, based on total mass of the regenerated aqueous amine solution.

16. The method of claim 13, wherein bis-(2-hydroxyethoxyethyl) urea is produced at a rate of about 3 wt. % or more per day, based on total mass of the regenerated aqueous amine solution, the method further comprising:
increasing the temperature of the at least partially regenerated aqueous amine solution in the reclaimer to within a range of 360° F. to 380° F.; and
returning the temperature of the at least partially regenerated aqueous amine solution in the reclaimer to within a range of 340° F. to 360° F. once bis-(2-hydroxyethoxyethyl) urea is produced at a rate of about 3 wt. % or less per day, based on total mass of the regenerated aqueous amine solution.

17. The method of claim 13, wherein the at least partially regenerated aqueous amine solution in the reclaimer is maintained at a temperature ranging from 340° F. to 350° F. if at least a portion of the bis-(2-hydroxyethoxyethyl) urea is converted to morpholine and the regenerated aqueous amine solution comprises about 3 wt. % or more morpholine, based on total mass of the regenerated aqueous amine solution.

18. The method of claim 13, wherein the at least partially regenerated aqueous amine solution or a portion thereof passes through an amine filter before being recirculated to the absorber tower, and the diglycolamine stream introduced to the reclaimer comprises a filtered diglycolamine stream obtained from the amine filter.

19. The method of claim 7, wherein the aqueous amine solution introduced to the absorber tower comprises 40 wt. % to 45 wt. % diglycolamine, based on total mass of the aqueous amine solution.
